(19) United States
(12) Patent Application Publication
(10) Pub. No.: US 2022/0077440 A1
(43) Pub. Date: Mar. 10, 2022

(54) POWERBANK

(71) Applicant: Design2Gather (Shanghai) Industrial Product Design Co., Ltd., Shanghai (CN)

(72) Inventors: Touba Daneshmandi, The Colony, TX (US); Kazen Daneshmandi, The Colony, TX (US); Owen de Vries, New York, NY (US); Polle van Duuren, Shanghai (CN)

(73) Assignee: WIIM INT, LLC, The Colony, TX (US)

(21) Appl. No.: 17/017,022

(22) Filed: Sep. 10, 2020

(51) Int. Cl. H01M 2/10; H01M 10/42

(52) U.S. Cl. CPC H01M 2/1005; H01M 2010/4271; H01M 10/4257

(57) ABSTRACT

A powerbank with comfort wearing, a beautiful appearance and higher battery capacity. The powerbank is not only used as a mobile charging but may also be used as a charging cable. The powerbank has a central unit; a first flexible strap; a second flexible strap; a first plug; a second plug; and wherein the first flexible strap and the second flexible strap are respectively connected to the sides of the central unit; and wherein the first plug is connected to the central unit and extends out from one side of the first flexible strap; and wherein the second plug is placed at the top end of the second flexible strap.

### FILED OF THE EMBODIMENTS

The field of the invention and its embodiments relates to the mobile charging technical area, specifically, relating to a kind of powerbank.

### BACKGROUND OF THE EMBODIMENTS

For the purpose of mobile charging, one can find several types of ‘powerbanks’ to charge phones and electronic devices in the market. Ordinary powerbanks usually have large capacities which are several times as that of one's phone. As a result, they are relatively large and heavy. A typical Li-ion powerbank of 10.000 mAh capacity has a volume of ˜120 cm³ and weighs ˜200 g. Therefore, their suitability for light weight user scenarios is limited (e.g. short hike, holiday outings, city run).

In recent years, some products have entered the markets that are wearable mobile powerbank (bracelet), these come with smaller capacities for the convenience of carrying. There are some different approaches of placing the components to enable the accurate charging of phones. For example, the bracelet itself might have a female USB outlet or micro USB outlet, using a separate charging cable to charge one's phone, or it also might have a direct phone charger incorporated.

However, while the existing wearable powerbanks have advantages such as light and handy, there are still some weaknesses:
1) Some bracelet powerbank designs opt for a (micro) USB outlet instead of direct phone charge outlet, so an additional cable is necessary, and the product is not ‘stand-alone’, it is not convenient for carrying or using;
2) Most of the products that can be seen in the market or concept products are with a closing plastic/metallic ring or a fixed size silicone ring, so the bracelet cannot be adjusted to different wrist sizes due to the architecture. As a result, the wearing comfort during its most relevant use scenarios (such as moving) is limited due to the loose fit.
3) Poor battery performance due to plastic or silicone material limits the cooling of the battery;
4) Materialization and product build up results into larger wall thicknesses (2 mm and up) and larger connective area's between product parts. Also, the protrusion from the wrist is kept at minimum to ensure comfort. The aforementioned all go at the cost of battery volume. In addition, curved batteries have typically a smaller power capacity compared to regular batteries. Therefore, the battery capacity is often low (200-400 mAh);
5) Due to the embedding method of some wearable power banks, any form of perforation, clamping or otherwise will either completely break or affect the electric wiring. Therefore, common closing mechanisms (such as buckle, pin-slot, etc.) are usually not used so far on wearable powerbanks. Instead, the form of a sliding closing mechanism is usually used, in which the phone charger side and the powerbank-charge side slide over each other at the bottom of the wrist, hence closing the bracelet into a fixed loop. This type of closing is widely used in the market as it is affordable and proven to be reliable. For example, it can be seen also on wearable charging cables (non-power bank). However, it requires very precise movements that some users might have difficulty in performing. In addition, it creates a high bulge of hard plastic (such as more than 10 mm), located at the bottom of the wrist, that will result in discomfort when hands are on a flat surface, such as during desk work. Additionally, it cannot be adapted to different wrist sizes.

### SUMMARY OF THE EMBODIMENTS

The problems to be solved and the purpose of this invention is to provide a powerbank with comfortable wearing, beautiful appearance and higher battery capacity, it can be acted as a powerbank to charge one's phone and also as a cable to connect a phone and other devices. The technical means to solve the above problems include, this invention provides a powerbank, including: The central unit of the powerbank, the said central unit includes battery, the PBC underneath the battery and the shell containing the said battery and PBC; The first flexible trap connected with one side of the shell; and the second flexible strap connected with the other side of the shell; One plug (first plug) for charging the powerbank and another plug (second plug) for external charging are attached to the said PBC.

It can also be, in this invention, the locking pin is placed on the first flexible strap for closing the bracelet, several locking pinholes that are coincided with the said locking pin are placed on the second flexible strap. As a result, the user enables adjustment to wrist size and improves comfort during wearing.

It can also be, in this invention, The said first plug is extended from the said shell towards underneath the first flexible strap; The second plug is extended from the tip end of the second flexible strap, and connected to the PCB by a cable embedded in the second flexible strap which is designed to avoid the several locking pinholes. Therefore, both the first plug and the second plug are hidden under the flexible straps when wearing, which makes the powerbank beautiful and elegant, at the same time, the second plug is extended out from the tip end of the flexible straps, which makes it easy to use and ensures the effective length of the powerbank when it is acted as a cable.

It can also be, in this invention, The said first and second flexible straps are covered by silicone straps with fabric lamination, the flexible strap has good flexibility, comfortable wearing and beautiful decoration, and allows the cable to be flexed with it freely.

It can also be, in this invention, the said shell includes the metal top cap used to cover the battery, and the metal is preferred to be aluminum; the said battery capacity is 700 mAh. Therefore, battery cooling is improved, and a high capacity battery is allowed within a narrow room.

It can also be, in this invention, A LED light for showing the working status of the said powerbank and the button for operating the said powerbank which are electrically connected with the said PCB are placed at the central unit of the said powerbank.

The effects of this invention as stated above, this invention is easy to use and carry, comfortable to wear, with beautiful appearance and higher battery capacity, it can charge phone and other devices as a wearable powerbank, and also can be as a wearable cable to connect phone and other devices so that the powerbank and the phone can be charged at the same time by using external devices.

### BRIEF DESCRIPTION OF THE DRAWINGS

FIG. 1 is the front view of the schematic diagram of the powerbank according to one implementation and embodiment of the present invention.

FIG. 2 is the sectional view of the central unit of the powerbank of the present invention.

FIG. 3 is the 3D view of the powerbank of the present invention.

FIG. 4 is the 3D view of the first flexible strap flexed upward the present invention.

FIG. 5 is the internal structure perspective view of the second flexible strap of the powerbank

FIG. 6 is the top view of the powerbank of the present invention.

FIG. 7 is the schematic diagram of the PCB of the powerbank of the present invention.

### DESCRIPTION OF THE PREFERRED EMBODIMENTS

The preferred embodiments of the present invention will now be described with reference to the drawings. Identical elements in the various figures are identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto. This invention is further illustrated below in combination with the drawings and the following embodiments, it should be understood that the drawings and the following embodiments are only used to illustrate the invention and are not to limit the scope of this invention.

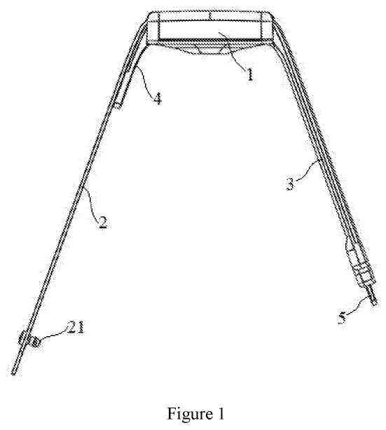

We hereby disclose a powerbank with comfort wearing, beautiful appearance and higher battery capacity. The powerbank is not only used as a mobile charging but also as a charging cable FIG. 1 is the front view of the schematic diagram of the powerbank according to one implementation mode of this invention. FIG. 1 shows the implementation mode of the powerbank includes: central unit: (1); the first flexible strap (2); the second flexible strap (3); the first plug (4) and the second plug (5). The first flexible strap (2) and second flexible strap (3) are respectively connected with the two sides of the central unit of the powerbank (1) (for example, the left and right sides in FIG. 1). The first plug (4) connected with the central unit (1) of the powerbank extends out from one side of the first flexible strap (2). The second plug (5) is placed at the tip end of the second flexible strap (3).

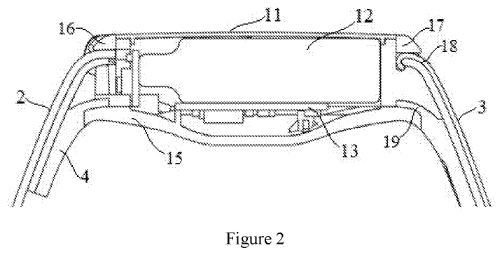

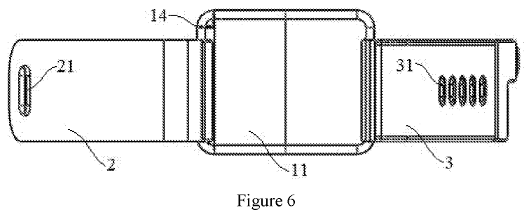

Furthermore, FIG. 2 is the sectional view of FIG. 1. FIG. 6 is the top view of FIG. 1. FIG. 2 and FIG. 6 show the central unit of the powerbank (1) can roughly form the shape of a watch head, including shell (10), battery (12) which is incorporated in shell (10), and PCB (13).

The shell (10) is the external layer of the central unit of the powerbank (1), and it is used to protect the internal components. The shell (10) consist of the bottom (15) and a metal top cap (11), the top cap can be made of aluminum based metal such as aluminum alloy containing zinc or magnesium or other metals which have good manufacturability and lifetime performance. The battery (12) is placed on the top of the internal room covered by the shell (10). The top cap (11) covers the battery (12) from the top and is attached to the battery (12), so as to efficiently transfer the heat generated by the battery (12) to the outside of the powerbank, which ensures that the battery (12) has an excellent performance with a smaller size.

The PCB (13), as the carrier of the electrical connection of the electronic components, is located under the battery (12) in the form of a downward bulge. The bottom (15) of the shell (10) is also with a slight downward bulge suitable for the wrist's soft tissue, so as to ensure that the central unit (1) of the powerbank is relatively small and to improve the comfort when wearing. The first plug (4) and second plug (5) are attached to PCB (13). The first plug (4) is the input port which can be for example a USB-A plug for charging the powerbank. The second plug (5) is the output port which can be for example a lightning or USB-C plug for external charging.

In addition, as illustrated by FIG. 6, in the central unit (1) (in this embodiment the LED components are at the top left arc corner of the first flexible strap (2) which is closer to the central unit (1)), there are LED components (14) and a button for operating the powerbank which are electrically connected with the PCB (13). The LED components (14) include the LED indicator light for showing the working status of the powerbank. The corner is arc-shaped, the top of which is made of soft and semi-transparent silicone component, and the bottom of which is made of hard plastic component. The silicone component has a split line. The LED indicator light and the button are positioned on the two sides of the split line and are embedded inside the silicone component. When the button is pressed, the LED indicator light will indicate the battery status, connectivity and charge level by (off/blink/on). The LED components (14) can be placed on any corner of the central unit (1) or on any side of the central unit (1) or other places for the ease of operation and observation. Users can conveniently confirm the battery level and working status of the power bank via the LED components.

In this embodiment, by mounting the PCB (13) underneath the battery (12) with components facing down, it forms a bulge on the bottom (15) of the shell (10) which falls into the soft tissue on top of the wrist while wearing. In this manner almost all internal room of the central unit (1) can be used for the battery (12) volume. In addition, as mentioned above, the cap (11) of the shell (10) which is made of metal instead of plastic can be directly connected with the battery (12), which achieves better protection and heat conductivity with smaller thicknesses, as well as limits the wall thicknesses of the central unit (1). As a result, the internal room of the central unit (1) has been enlarged.

Furthermore, the first flexible strap (2) and the second flexible strap (3) will be assembled from the inside outward, hooking behind the plastic structure of the central unit (15) at points (16) and (17). The result is a structure where no extra hooks, snaps or other type of fixture is needed in the central unit (1) to keep components in place, hence keeping room available for the battery. Specifically, as illustrated by FIG. 2, inner ends of the flexible straps (2) and (3) are permanently connected to a plastic ‘insert’ during the injection molding process. These hard-plastic inserts (19) and (20) hook behind the structure of the central unit (15) at (16) and (17) respectively. Their geometries and rigidity prevent the straps from being pulled out of the central unit (15). In summary of the above, the battery (12) volume can be increased by fully using the internal room of the central unit (15). In this implementation mode, the capacity of the battery (12) can be 700 mah, and this capacity is such that it can provide a ˜20%-30% charge, depending on the type of the phone.

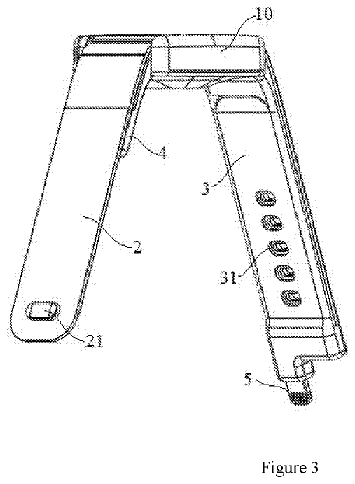

FIG. 3 is the 3D view of the powerbank in FIG. 1. FIGS. 2 and 3 show that this powerbank also includes the first flexible strap (2) and the second flexible strap (3) placed at the two sides of the central unit (1) (for example, the left and right sides in FIG. 1). The first flexible strap (2) and the second flexible strap (3) can be flexible silicone straps, and also can be silicone straps covered with fabric lamination, which enables good flexibility, wearing comfort and beautiful appearance.

Specifically, FIG. 1 to FIG. 3 show that the first flexible strap (2) is connected with the left side of the shell (10), and a locking pin (21) for closing is placed nearby the tip end of the first flexible strap (2). The second flexible strap (3) is connected with the right side of the shell (10), and several locking pinholes (31) are placed on the second flexible strap (3) in a form of straight line according to the extension direction of the second flexible strap (3). The locking hole (31) is a through-hole through the upper and lower surfaces of the second flexible strap (3) and is formed into a shape consistent with the locking pin (21). The said locking pin (21) can be formed into a bulge from the inner surface of the first flexible strap (2), which has the structures of a neck and a head, the diameter of the neck part is equal to or slightly smaller than the diameter of the locking hole (31), and the diameter of the head part is larger than the diameter of the locking hole (31).

When wearing, the first flexible strap (2) covers the external side of the second flexible strap (3), and the locking pin (21) is embedded into the locking hole (31) to close the bracelet. As a result, the locking pin (21) is allowed to be pressed into the suitable locking pinholes (31) to adjust the wearing size according to the size of the user's wrist and thus it improves the wearing comfort. In addition, no matter whether putting the locking pin (21) into the locking pinhole (31) or separate them, the second flexible strap (3) always stays automatically in place and will not shift due to buckling or opening the wiring because the direction of the force for closing is perpendicular to the wrist, rather than tangential, which results in the product moving. The interaction for our pin-hole principle is more convenient and requires less fine-motoric control. The product opening from the wrist is also perpendicular and can be done with 1 hand very swiftly.

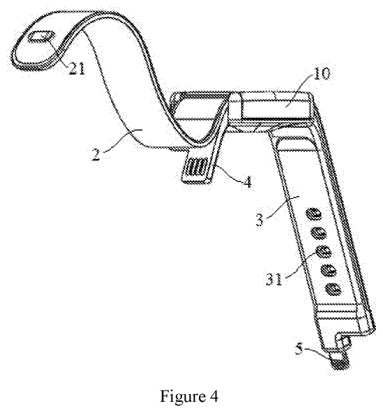

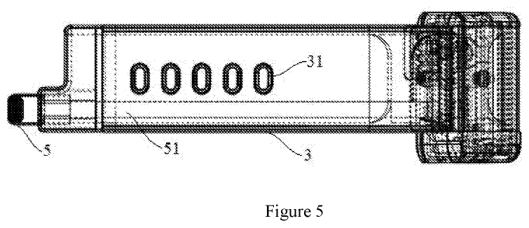

FIG. 4 is a 3D view showing the powerbank when the first flexible strap is flexed upward, FIG. 5 is a perspective view of the internal structure of the second flexible strap, and FIG. 6 is a top view of the powerbank in FIG. 1.

FIG. 2 and FIG. 4 show that the first plug (4) is electrically connected with the PBC (13) and extends outward from the left side of the shell (10) to the underneath part of the first flexible strap (2). The first plug (4) is covered by the first flexible strap (2), as shown in FIG. 6, when looking down from the top, the first plug (4) is overlapped with the first flexible strap (2) and is hidden under the inner side of the first flexible strap (2).

The second plug (5) is electrically connected with the PBC (13) through the flexible cable (51) and extends from the tip end of the second flexible strap (3). FIG. 5 shows that the cable (51) is embedded inside the second flexible strap (3) in the form of avoiding several locking pinholes (31), for example, the cable can be embedded by way of compression moulding. The cable (51) can be electrical connected with PCB (13) through the inner side of shell (10). In addition, the setting positions of the second plug (5) and the cable (51) are not limited to the positions as shown in the Figures. In the case the second plug (5) is set on the other side of the tip end of the second flexible strap (3), the cable (51) can be embedded inside the other side of the second flexible strap (3) to avoid the several locking pinholes (31).

When the first flexible strap (2) and the second flexible strap (3) are buckled, such as when wearing on the user's wrist, the first flexible strap (2) covers the external side of the second flexible strap (3), so that the second plug (5) can also be hidden in the inner side of the first flexible strap (2). Also, as the curvature radius of the first flexible strap (2) is slightly larger than the curvature radius of the second flexible strap (3) in the case of buckling, thus providing a space for the first plug (4) under the first flexible strap (2), and this asymmetric structure further improves the wearing comfort.

In this way, the battery is charged by the first plug (4), the mobile phone and other devices will be connected to the second plug (5) after finishing charging the powerbank, therefore, the powerbank can function as a mobile charging. At the same time, when the first plug (4) is connected to a computer and other devices, and when a mobile phone is connected to the second plug (5), both the powerbank and the mobile phone can be charged at the same time, that is, the powerbank can also be as a cable.

According to the structure mentioned above, the buckle structure of the two flexible straps allows adjustment according to the user's wrist size, the first plug and the second plug are hidden in the inner side of the flexible straps when wearing, which makes it beautiful and easy to use, and the aluminum top cap improves the cooling of the battery. The powerbank is light and easy to use, comfortable to wear, beautiful and with high battery capacity, and can be used for charging mobile phones and other devices. At the same time, the bracelet can also be used as a wearable cable to connect the mobile phone and other devices, by using external devices to charge both the powerbank and the mobile phone at the same time. The second plug extends from the tip of the flexible straps, which also ensures the required length of the cable.

In addition, the combination of metal, plastic, silicone and textile parts creates a beautiful appearance of the powerbank, and it can be as an ornament when wearing.

Other embodiments. The embodiments above explained about the functions of the power bank as a charging device and as a cable for connecting a phone with other devices. In addition, the power bank can also achieve other functions by modifying the PCB, such as data transmission.

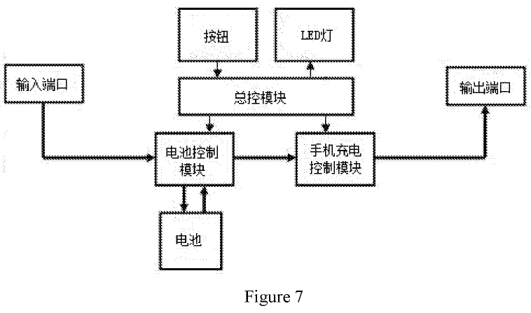

FIG. 7 is the schematic diagram of the PCB of the powerbank of FIG. 1. Below is a brief explanation of the working principle and circuit control of the powerbank based on FIG. 7. The master control module, battery control module, and mobile phone charging control module shown in FIG. 7 are all set on PCB (13). They form the control circuit of the powerbank together with the input port (the first plug (4)), the output port (the second plug (5)) and the battery (12). The master control module is used to determine the current connection status of the powerbank and to send control signals to the battery control module and the phone charging control module. The input port and the output port are respectively connected to the positive and negative poles of the battery (12) by wires. The battery control module is located between the input port and the battery (12) and is mainly used to control the charging and discharging of the battery (12) in accordance with the signals of the master control module. The mobile phone charging control module is located between the battery control module and the output port and is used to charge the mobile phone in accordance with the signals of the master control module. The mobile phone charging control module also includes a module for raising voltage which is not shown in FIG. 7, which can raise the voltage of the battery (12) to the standard voltage required by mobile phones.

With the above-mentioned control circuit, the powerbank can perform under the 3 working status below:
1) Charge a mobile phone as a powerbank. When the input port is disconnected and the output port is connected to a mobile phone, the master control module sends signals to the battery control module and the mobile phone charging control module, so that the battery control module allows the battery (12) to release electricity, and the module for raising the voltage will raise the voltage of the battery (12) to the standard voltage required by the mobile phone, thereby charging the mobile phone through the output port to achieve the mobile phone charging function;
2) use an external power source to charge the powerbank. When the input port of the powerbank is connected to an external power supply via the AC adapter and when the output port is disconnected, the master control module send a signal to the battery control module to allow the external power supply to charge the battery (12) via the input port via the AC adapter;
3) The external power source charges both the mobile phone and the battery (12) inside the powerbank. When the input port is connected to the external power supply via the AC adapter and when the output port is connected to the mobile phone, the master control module can charge the internal battery (12) and the mobile phone at the same time or only the mobile phone. Specifically, under this working mode, when the external power supply is insufficient the master control module sends a signal to the battery control module to temporarily ignore the battery (12) and charge the mobile phone on priority. When the external power supply is sufficient, the master control module sends a signal to the battery control module and the mobile phone charging control module to allow simultaneous charging of the mobile phone and the battery (12).
   The master control module is also electrically connected to the aforementioned LED components (14) and the button. If the button is pressed when the powerbank is not connected to any device, the master control module will instruct the LED light indicator to show the current battery status of the power bank. If the button is pressed when the powerbank is connected to an external power supply and/or a mobile phone, then the master control module sends signals to the battery control module and the mobile phone charging control module according to the 3 working status above, allowing the battery (12) to be charged or discharged, and to charge the mobile phone, while the current charge and discharge status of the battery is displayed on the LED. In addition, the charge/discharge function can also be turned on automatically when the input port is connected to an external power supply and/or the output port is connected to a mobile phone. The button is only used to operate the LED light indicator.

Additionally, two wires for data transmission can be installed in the aforementioned circuit, which may be directly connected to the input port and the output port when the powerbank is used as a data cable, thereby forming a data channel between the mobile phone and an external device.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

The above mentioned specific embodiments further explain the purpose, technical proposals and beneficial effect of the invention, it should be understood that the previous statement is only one specific implementation mode of the invention, and is not a limitation to the protection scope of the invention. Without departing from the basic features of this invention, this invention can be embodied in various modes, so the embodiments hereunder are used for illustration rather than limiting the scope of this invention. Since the scope of this invention is limited by the claims rather than by the specifications hereunder, any variations falls within the scope defined by the claims or their boundaries and any variations falls within the equivalent scope of the prescribed scope should be understood to be included in the claims. Any modification, equivalent replacement, improvement, etc. made within the spirit and principle of the invention shall be included in the protection scope of this invention.

1. A powerbank comprising:
a central unit;
a first flexible strap;
a second flexible strap;
a first plug;
a second plug; and
wherein the first flexible strap and the second flexible strap are respectively connected to the sides of the central unit; and
wherein the first plug is connected to the central unit and extends out from one side of the first flexible strap; and
wherein the second plug is placed at the top end of the second flexible strap.

2. The powerbank of claim 1, further comprising am external layer or shell, a battery and a PCB.

3. The powerbank of claim 1, wherein the shell comprises a top cap.

4. The powerbank of claim 1, wherein the top cap is comprised of an aluminum-based alloy containing zinc or magnesium or other metals.

5. The powerbank of claim 1, wherein the top cap covers the battery and is attached to the battery, wherein heat that is generated by the battery is transferred to the outside of the powerbank.

6. The powerbank of claim 1, further comprising a bottom portion of the shell.

7. The powerbank of claim 6, wherein the bottom portion of the shell is comprised of a downward bulge.

8. The powerbank of claim 1, wherein the first plug and the second plug are attached to the PCB.

9. The powerbank of claim 8, wherein the first plug may comprise an input port.

10. The powerbank of claim 8, wherein the second plug may comprise an output port.
